(19) United States
(12) Patent Application Publication
(10) Pub. No.: US 2006/0197702 A1
(43) Pub. Date: Sep. 7, 2006

(54) Wireless host intrusion detection system

(75) Inventor: Emanuele Jones, Ottawa (CA)

Correspondence Address: KRAMER & AMADO, P.C., Suite 240, 1725 Duke Street, Alexandria, VA, 22314, US

(73) Assignee: ALCATEL, Paris (FR)

(21) Appl. No.: 11/067,945

(22) Filed: Mar. 1, 2005

(51) Int. Cl. G01S 13/08; G08B 1/08; H04Q 7/00

(52) U.S. Cl. 342/126; 340/539.13

(57) ABSTRACT

Systems and methods of detecting, and dealing with, a man-in-the-middle attack in wireless communications systems are described. The invention operates on the principle that if a mobile terminal is stationary there should be no reason for the access point to which it communicates to hand-over the connection. A hand-over, from the legitimate access point to a rogue access point can be detected by: the occurrence of a full hand-over procedure or simply by detecting a change in signal from the access point, either signal strength or direction of arrival. This indicates the initiation of an attack. Upon detecting such a man-in-the-middle attack, appropriate alerting actions are taken.

### FIELD OF THE INVENTION

The present invention relates to wireless communications systems and more particularly to systems and methods for detecting intrusion attacks in such communications systems.

### BACKGROUND

In present day communications networks, in general, there must be an assurance that security factors, including unwanted intrusions from rogue attackers, are fully satisfied. To this end considerable effort is being, and has devoted to finding ways of preventing unwanted attacks by malicious and ingenious hackers. As new solutions are introduced, attackers find ways of counteracting them.

Since communications systems relying on optical and wired mediums have been around for many years, most of the security solutions have been developed for these technologies. With the rapid recent growth of wireless communications, however, a new set of solutions devoted to this technology is needed.

Due to its nature, wireless communication is prone to attacks from sources that may simply be eavesdropping on private conversations. One such attack is known as a man-in-the-middle attack, so named because the intruder is able to spoof the victim's true access point. Because of this phenomenon, wireless terminals, including cellular phones, can be tricked into associating its communication to a rogue access point or base station. The attacker will then establish a second connection to the real access point and relay traffic coming from the victim, after eavesdropping and possibly manipulating data.

In particular an attacker could force a wireless device already connected to a legitimate access point to disassociate from it and immediately associate to the attacker itself. All this could take place without the user realizing any of it. An attacker acting as man-in-the-middle is in the position to mount many attacks on wireless users.

Wireless network auditing tools, such as Netstumbler may detect rogue access points if these are active during an audit. Nonetheless, this class of tools is not designed to defend the wireless user, since in most cases a user will not have the knowledge to distinguish packets advertising a legitimate access point from packets advertising a malicious (fake) access point. In fact, the goal of the user is simply to associate to any available access point that looks reasonably legitimate in order to access the Internet.

Traditional host Intrusion Detection Systems (IDS) can be adapted to monitor the wireless interface on a host or directly on an access point. These solutions are designed to detect signals of an attacker penetrating the host itself. They are not capable of detecting threats lying in between the host wireless interface and the access point.

A publication by Joshua Wright entitled “Detecting Wireless LAN MAC Address Spoofing” (http://www.polarcove.com/whitepapers/detectwireless.pdf) describes an analysis of the anomalies generated by different tools that spoof MAC address in a wireless network. Spoofed MAC addresses are used to mount man-in-the-middle attacks.

Knowledge of these anomalies allows for an easy detection of the spoofed traffic generated by those tools. Even though these detection methods work in the case of the specific attack tools described by the above identified paper, they cannot be generalized since they rely on a “design flaw” of the specific attack tools. The next release of the attack tools will be patched to randomize the field currently matched by the signature.

Prior art solutions are not designed to detect malicious activities that take place between the user interface and the access point. This problem is not addressed by prior art solutions at the wireless physical layer. Moreover, the majority of prior art IDS solutions are focused on 802.11 technology only, while the present invention conceptually addresses all wireless technologies including mobile phones.

### SUMMARY OF THE INVENTION

The present invention provides methods and apparatus for detecting abnormal behaviour of an Access Point communicatively coupled to a wireless device via a wireless connection. Specifically, the abnormal behaviour is an apparent change in signal from the access point in relation to the wireless device when the wireless device has remained stationary. Such abnormal behaviour could indicate a malicious act such as a “man in the middle” type attack. The wireless devices may include mobile devices such as PDAs, laptops, cell phones, and other “less mobile” devices that have wireless network connections such as desktop PCs, gaming stations etc.

Therefore, in accordance with a first aspect of the present invention there is provided a method of detecting an abnormal condition in wireless communications between a wireless device and an access point, the method comprising the steps of: detecting an apparent change in a signal from the access point; determining whether the wireless device has remained stationary since a time prior to the detection; and raising an alert to an abnormal condition responsive to the determination being affirmative.

In a preferred embodiment of the method, the change in signal from the access point is a change in strength and/or direction.

In accordance with a second aspect of the invention there is provided a system for detecting an abnormal condition in wireless communications between a wireless device and an access point, the system comprising: means for detecting an apparent change in a signal from the access point; means for determining whether the wireless device has remained stationary since a time prior to the detection; and means for raising an alert to an abnormal condition responsive to the determination being affirmative.

### BRIEF DESCRIPTION OF THE DRAWINGS

The invention will now be described in greater detail with reference to the attached drawing which shows am example of a man-in-the-middle attack during a conference connection.

### DETAILED DESCRIPTION OF THE INVENTION

As suggested previously, a man-in-the-middle attack is carried out by an attacker interceding between a wireless device and the access point to which the wireless terminal is communicating. A man-in-the-middle attack may be simply to cause inconvenience to a user of a wireless terminal or, more likely, it may be to eavesdrop in order to gain important information or provide erroneous information.

The solution provided by the present invention operates on the principle that an access point should not be perceived as moving if the mobile terminal of the user is not moving. That is to say, if the user knows that his mobile terminal is standing still, then there is no reason why the access point associated to the terminal should exhibit characteristics generally observed only while the user is moving. The obvious access point characteristic perceived by a mobile terminal that is moving is the access point hand-over; the less obvious ones are change in strength and direction of arrival for the signal for the access point. In fact, it is very unlikely that an access point or a BTS, BSS would change position and still be kept operational by the wireless network operator. Thus, it is reasonably safe to assume that if the access point is perceived as moving something suspicious is happening.

This invention can find application in telephone mobiles terminals such as second generation (2G), and third generation (3G) terminals, as well as to broadband technology such as WiFi, WiMax, Bluetooth and other wireless technologies, including ad-hoc deployment scenarios. For the sake of clarity, from here on, this application will make specific reference to WiFi technology. Of course, it would be obvious to anyone knowledgeable in the field of the invention (wireless communications and security) to apply the concepts behind this invention to other wireless technologies.

In particular, the appearance of a rogue access point located in a different position than the legitimate access point would be perceived as an abrupt movement. This event should be signaled as a suspicious activity to the user and/or to any security application running on the host and/or via a different channel to the wireless network operator running the access points. Imagine a wireless service provider offering Universal Mobile Telecommunication System (UMTS) and WiFi connectivity to its users. In this case a WiFi plus UMTS phone (using an application of this invention) detecting a rogue WiFi access point could alarm the user directly and in the mean time notify the wireless network operator via a message, such as a Short Message Service (SMS), over UMTS.

In order to detect the appearance of a rogue access point, the current invention relies on the correlation two pieces of information:

(1) Is the user moving or not?

(2) Does the access point seem to be moving or not?

First, to determine if a user is moving or not, several techniques and technologies can be used. For example, Global Positioning System (GPS) and its newest variant Assisted GPS (A-GPS) are becoming commonly available on a number of mobile devices including cell-phones (Motorola i88S among others), PDAs and Laptops. This positioning system can be immediately used to determine if a user is moving or standing still. Moreover, the FCC's e911 act is requesting that cell phones in the U.S. be capable of broadcasting their position to assist in emergency calls. If the geographical coordinates are constant over time the mobile terminal is standing still.

Another possible way of detecting if the wireless mobile terminal is moving is through a second wireless interface directly available on the mobile terminal. If the mobile terminal features more than one wireless interface, then positioning techniques related to one of the available wireless networks can be used to determine the mobile terminal position. In particular triangulation techniques such as Enhanced Observed Time Difference (EOTD) for GSM networks and Advanced Forward Link Trilateration (AFLT) for CDMA networks can be employed today to determine the position of a mobile phone without relying on GPS. Similar triangulation techniques could be ported to the WiFi technology.

Moreover, this invention is not concerned with precise information about the geographical position of the mobile terminal. This invention is proposing that computation of the position of the mobile terminal may be the easiest and most practical way to determine if the mobile terminal is moving or not. Hence, if some of the above methods do not provide enough accuracy in computing the geographical coordinates, their infrastructure and technologies may be easily adapted to solve a slightly different task, i.e. determine if a mobile terminal is moving or not.

Imagine a scenario where the 3G phone wireless infrastructure is trusted by the user, but no GPS is available on the mobile terminal. Strength and direction of the arrival of trusted base stations signals could be monitored to determine when the mobile terminal is moving and when it is standing still. Meanwhile over the remaining Bluetooth and WiFi interfaces (of the same mobile terminal), the access point signal's strength and direction would be monitored to detect the presence of rogue access points. Depending on the available wireless interfaces and networks infrastructures, many more methods could potentially be engineered to determine if a mobile terminal is moving or not with any desired accuracy. This invention could potentially make use of any of them.

Provided that a terminal can determine that it is currently not moving, the strength and direction of the signal coming from the Access Point that the terminal is currently associated to must stay constant. As mentioned previously, a change in the signal, such as signal strength and/or direction of the signal, is an indication of a hand-over, which should not be happening unless an attack is under way.

Signal strength monitoring is already available on all WiFi wireless cards. Detecting the Direction of Arrival (DOA) is a capability, although not widespread on commodity hardware, is nonetheless a well understood engineering problem today. Consequently, both signal strength monitoring and DOA functionality can be incorporated into mobile technology.

In conclusion, if the mobile terminal is not in any hand-off scenarios, then the signal coming from a rogue access point (impersonating the legitimate one but located somewhere else) will reach the mobile terminal with a different strength and/or direction of arrival.

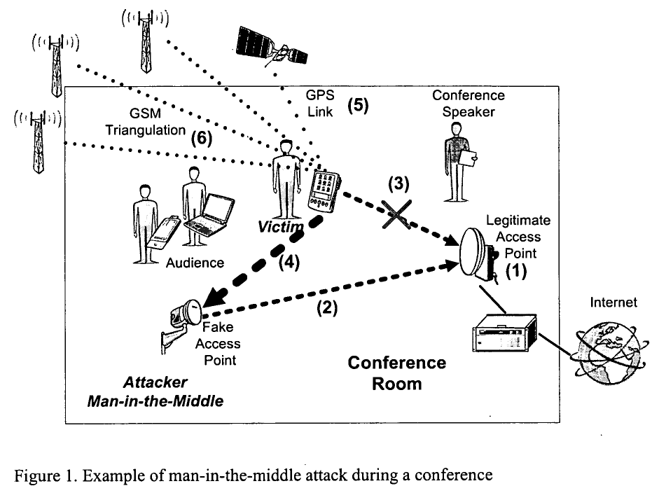

An example of a man-in-the-middle attack is illustrated in FIG. 1. In the Figure, imagine a conference room where many attendees in the audience are using their laptops or PDAs over a legitimate WiFi connection. The legitimate access point 1 is located next to the speaker. A man-in-the-middle attacker sitting at the back of the room could establish a connection 2 to the legitimate access point 1 and then start to force a given user (victim) to disassociate with the legitimate access point 1 over previously used link 3 and associate to the attacker's fake access point via link 4. The attacker could then relay the wireless traffic of the victim to the access point and successfully become a man-in-the-middle. This kind of situation would immediately be detected by solutions implementing this invention. In fact, all of a sudden, with the mobile terminal standing still, the direction of the access point signal would change by almost 180 degrees and very possibly also the strength of the access point signal via link 4 would change. The victim's mobile terminal could easily determine that it is currently standing still using GPS (5) or a GSM triangulation (6). This would be reported to the user of the mobile terminal.

Another typical scenario (not shown) could be a home wireless network and an attacker parked just on the opposite side of the road (or a curious neighbor) silently eavesdropping on all domestic wireless traffic.

This invention can be enhanced by correlating any available information on the mobile terminal itself about access point association and de-association in order to improve the accuracy of the detection

The functionality of the present invention can be used to increase the confidence that a mobile terminal (user) has towards the legitimacy of the access point that it is currently associated to. The different pieces of information required by this invention are widely available today, some do not even require any wireless protocol or infrastructure modification.

This solution can be seamlessly integrated with any other security mechanism to authenticate access points or to protect the privacy of the wireless traffic. This will result in more secure wireless deployments

Some methods described above, that are used to determine if a mobile terminal is moving or not, may not immediately provide the accuracy needed by certain wireless scenarios. In all such cases the user's direct feedback regarding the fact that the terminal is moving or not may be confidently used. In an alternative, already available technologies (e.g. e911) can be modified to better support a mobile terminal in determining weather it is standing still or not.

This invention would increase the security in mobile communications. This should help raising the level of trust towards wireless technologies and thus foster their adoption by more users. Moreover, wireless network operators could directly benefit from mobile terminals capable of reporting any detected fake access points, as described earlier.

In the near future government, and other security concerned entities, may require a certain level of security features in their wireless communication devices and in specific wireless infrastructures; this invention could help by providing detection of eavesdropping.

Although specific embodiments of the invention have been described and illustrated, it will be apparent to one skilled in the art that numerous changes could be introduced without departing from the basic concept. It is to be understood, however, that such changes will fall within the full scope of the invention as defined by the appended claims.

1. A method of detecting an abnormal condition in wireless communications between a wireless device and an access point, the method comprising the steps of:
a) detecting an apparent change in the signal from the access point;
b) determining whether the wireless device has remained stationary since a time prior to the detection; and
c) raising an alert to an abnormal condition responsive to the determination being affirmative.

2. The method as defined in claim 1 wherein the step of determining whether the wireless device has remained stationary is determined using GPS in the wireless device.

3. The method as defined in claim 1 wherein the step of determining whether the wireless device has remained stationary is determined using triangulation by the wireless device.

4. The method as defined in claim 3 wherein the triangulation is conducted using EOTD for GSM.

5. The method as defined in claim 3 wherein the triangulation is conducted using AFLT for CDMA.

6. The method as defined in claim 1 wherein the step of determining whether the wireless device has remained stationary is determined using strength & direction of a trusted base station's signals.

7. The method as defined in claim 1 wherein the step of determining whether the wireless device has remained stationary is determined by asking the user of the wireless device.

8. The method as defined in claim 1 wherein an apparent change in the signal from the access point is a change in signal strength.

9. The method as defined in claim 1 wherein an apparent change in the signal from the access point is a change in signal direction.

10. The method as defined in claim 1 wherein an apparent change in the signal from the access point is a change in signal strength and signal direction.

11. The method as defined in claim 1 wherein the alert to an abnormal condition is raised by a message to a user of the wireless device.

12. The method as defined in claim 1 wherein the alert to an abnormal condition is raised by notification to a security application on the wireless device.

13. The method as defined in claim 1 wherein the alert to an abnormal condition is raised by a message to an AP operator.

14. A system for detecting an abnormal condition in wireless communications between a wireless device and an access point, the system comprising:
means for detecting an apparent change in position of the access point;
means for determining whether the wireless device has remained stationary since a time prior to the detection; and
means for raising an alert to an abnormal condition responsive to the determination being affirmative.

15. The system as defined in claim 14 wherein the change in signal from the access point is a change in signal strength detected by a signal strength monitor.

16. The system as defined in claim 14 wherein the change in signal from the access point is a change in signal direction detected by direction of arrival techniques.

17. The system as defined in claim 16 wherein the direction of arrival techniques involves a GPS in the wireless device.

18. The system as defined in claim 16 wherein the direction of arrival techniques involve triangulation by the wireless device.

19. The system as defined in claim 14 wherein the alert is a message to the user of the wireless device.

20. The system as defined in claim 14 wherein the alert is a notification to a security application on the wireless device.

21. The system as defined in claim 14 wherein the alert is a message to an AP operator.
